(19) United States
(12) Patent Application Publication
(10) Pub. No.: US 2012/0158434 A1
(43) Pub. Date: Jun. 21, 2012

(54) SYSTEM AND METHOD FOR PROVIDING CUSTOMIZED BUSINESS INSURANCE RECOMMENDATIONS

(75) Inventor: Jeffrey D. Reid, Weatogue, CT (US)

(73) Assignee: HARTFORD FIRE INSURANCE COMPANY, Hartford, CT (US)

(21) Appl. No.: 12/969,506

(22) Filed: Dec. 15, 2010

(51) Int. Cl. G06Q 40/00

(52) U.S. Cl. 705/4

(57) ABSTRACT

A display device may display to a user questions related to insurance products. The user may be a business owner, and the questions may solicit information that may be used to determine which of the insurance products are applicable to the user's business. Input data may be received from a user that is responsive to the questions. The input data may indicate, for example, the type of industry of the business, the number of employees in the business, the business's annual revenue, and/or goals of the user with respect to the insurance products. A determination may be made as to which of the insurance products are applicable to the business. The user may then obtain additional information related to the applicable products, initiate the purchase of one of the applicable products, and/or enter into a binding agreement for the purchase of one of the applicable product.

### TECHNICAL FIELD

The subject matter disclosed herein relates to computer systems and data communication systems. More particularly, the subject matter disclosed herein related to the electronic storage, communication, processing, and display of data related to business insurance and other insurance products.

### BACKGROUND

Insurance consumers benefit from insurance products such as property insurance, liability insurance, workers' compensation insurance, and other insurance products. Frequently, however, insurance consumers are not aware of which insurance products are applicable to them, or which may best meet their insurance needs. Therefore, new technologies are required that may be used by insurance consumers to determine which insurance products are applicable to them and best meet their insurance needs.

### SUMMARY

A system for the processing and display of information related to business insurance products offered by an insurance company may include a memory device that stores information related to at least two business insurance products. The system may also include a display device that displays information that indicates one or more questions related to a business. The one or more questions request information that describes a type of industry of the business, a number of employees of the business, and the annual revenue of the business. The display device may also display a field that indicates a number of the at least two business insurance products that are applicable to the business. The system may also include an input interface, which may receive input data from a user that is responsive to the questions. The system may also include at least one processor, which determines, for each of the questions, the number of the at least two business insurance products that are applicable to the business based on the input data. The at least one processor may also, for each of the questions, update the field that indicates the number of the at least two business insurance products that are applicable to the business. The at least one processor may also determine, based on the input data, which of the at least two business insurance products are applicable to the business. The display device may display information related to the determined business insurance products.

A computer-implemented method for the processing and display of information related to insurance products offered by an insurance company may include a memory device storing information related to at least two insurance products that may be purchased by an insurance consumer. The method may also include a display device displaying information that indicates one or more questions related to the insurance consumer and displaying a field that indicates a number of the at least two insurance products that are applicable to the insurance consumer. The method may also include an input interface receiving input data from a user, wherein the input data is responsive to the questions. The method may also include at least one processor determining, for each of the questions, the number of the at least financial products that are applicable to the insurance consumer based on the input data, and updating, for each of the questions, the field that indicates the number of the at least two financial products that are applicable to the insurance consumer. The method may also include the at least one processor determining, based on the input data, which of the at least two insurance products are applicable to the insurance consumer. The method may also include the display device displaying information related to the determined insurance products.

A computer-readable medium having processor-executable instructions stored thereon which, when executed by at least one processor, will cause the at least one processor to perform a method for the processing and display of information related to financial products offered by a financial services company. The method may include storing information related to at least two financial products that may be purchased by a consumer and displaying information that indicates questions of two types. The first type relates to attributes of the consumer, and the second type to goals of the consumer with respect to the at least two financial products. The method may further include displaying a field that indicates a number of the at least two financial products that are applicable to the consumer and receiving input data from a user, wherein the input data is responsive to the questions. The method may further include, for each of the questions, determining the number of the at least two financial products that are applicable to the consumer based on the input data and updating the field that indicates the number of the at least two financial products that are applicable to the consumer. The method may further include determining, based on the input data, which of the at least two financial products are applicable to the consumer, and displaying information related to the financial products that are applicable to the consumer.

### BRIEF DESCRIPTION OF THE DRAWINGS

A more detailed understanding may be had from the following description, given by way of example in conjunction with the accompanying drawings wherein:

FIG. 1 shows an example architecture for communicating, displaying, and processing data related to insurance products;

FIGS. 2A-2E show an example web page that includes one or more questions that solicit information from a business owner related to their business;

FIG. 3 shows an example results web page that includes information related to insurance products that have been determined to be applicable to a business;

FIGS. 4A-4B show a chapter menu in a Electronic Book (E-Book) that includes information related to an insurance product;

FIG. 5 shows a first page in a chapter from the E-Book of FIGS. 4A-4B;

FIG. 6 shows an example method for obtaining information about and/or selecting a business insurance product; and

FIG. 7 shows an example computing device that may be used to implement features described herein with reference to FIGS. 1-6; and

FIG. 8 shows an example cellular phone that may be used to implemented features described herein with reference to FIGS. 1-6.

### DETAILED DESCRIPTION

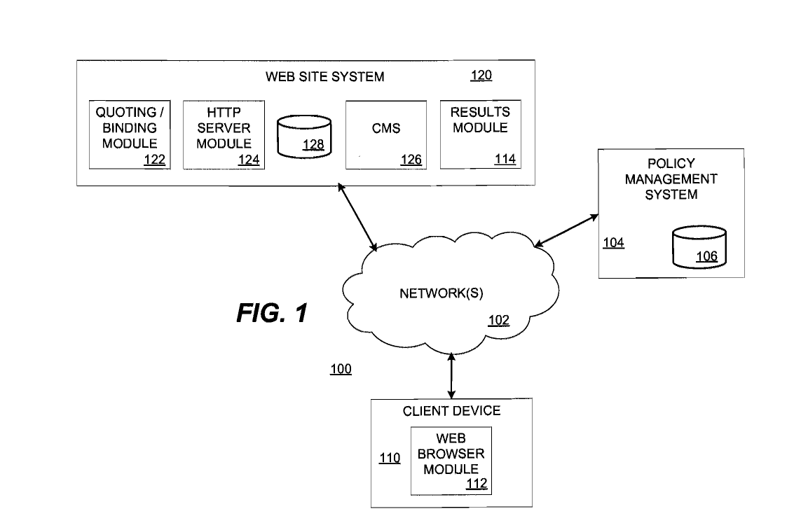

FIG. 1 shows an example architecture 100 for communicating, displaying, and processing data related to business insurance products. The example architecture 100 includes a web site system 120, a client device 110, a policy management system 104, and one or more communication networks 102. The web site system 120 may provide access to a web site that is managed by an insurance company. The client device 110 may access the web site via the one or more communication networks 102, and display the web site to a user of the client device 110. The user may be, for example, a business owner. The web site may include a page that includes questions of one or more types. As an example, questions of a first type may solicit information regarding attributes of the user's business, while questions of a second type may solicit information related to a user's goals and/or needs with respect to business insurance. The user may provide information that is responsive to the questions, which may then be transmitted to the web site system 120 by the client device 110. The web site system 120 may then determine, based on the information provided by the user in response to the questions, the insurance products that are applicable to the user's business. The web site system 120 may then transmit additional information back to the client device 110, related to the applicable products. Using the client device 110, the user may then obtain additional information related to the applicable products, initiate the purchase of an applicable product (by, for example, contacting an agent or employee of the insurance company), and/or enter into a binding agreement for the purchase of an applicable product.

The web site system 120 may include a HyperText Transfer Protocol (HTTP) server module 124, a Content Management System (CMS) 126, a product quoting/binding module 122, a web site database 128, and a results module 114. The HTTP server module 124 may implement the HTTP protocol, and may communicate HyperText Markup Language (HTML) pages and related data from the web site to/from the client device 110 using HTTP. The HTTP server module 124 may be, for example, an Apache HTTP server, a Sun-ONE Web Server, a Microsoft Internet Information Services (IIS) server, and/or may be based on any other appropriate HTTP server technology.

The web site database 128 may store information that describes the content of the web site. The web site database 128 may be a relational database, a hierarchical database, an object-oriented database, one or more flat files, one or more spreadsheets, and/or one or more structured files. The web site database 128 may be managed by a database management system (not depicted) in the web site system 120, which may be based on a technology such as Microsoft SQL Server, MySQL, PostgreSQL, Oracle Relational Database Management System (RDBMS), a NoSQL database technology, and/or any other appropriate technology. In addition to the page that includes one or more questions that solicit information regarding the user's business, the web site may include one or more Electronic Books (E-Books) that provide information related to the business insurance products offered by the insurance company. Information describing the web pages and the E-Books that constitute the web site may be stored in the web site database 128.

The CMS 126 may be used by administrators of the web site to manage the content of the web site stored in the web site database 128. The CMS 126 may change the content of the web site by adding, deleting, or modifying data in the web site database 128 via the database management system. The CMS 126 may be, for example, a Fatwire system, a Drupal system, a Joomla system, an IBM Lotus Web Content Management system, and/or may be based on any other appropriate CMS technology.

The quoting/binding module 122 may be or include one or more web applications that, in conjunction with the HTTP server module 124, the CMS 126, and/or the policy management system 104, may be used to provide one or more web pages to the client device 110 that provide a price quote for an insurance product offered by the insurance company. Alternatively or additionally, the one or more web applications, in conjunction with the HTTP server module 124, the CMS 126, and/or the policy management system 104, may be used to enter the user of the client device 110 into a binding agreement for the purchase of an insurance product via the web site.

As described above, the web site system 120 may transmit web pages to the client device 110 that may include one or more questions that solicit information regarding the user's business. This may be performed by, for example, the HTTP server module 124 in conjunction with the CMS 126 and/or the web site database 128. Also as described above, the user may provide information that is responsive to the questions, which may then be transmitted to the web site system 120 by the client device 110. The information may be received via the HTTP server module 124, which may then provide the information to the results module 114. The results module 114 may determine results information to send back to the client device 110, based on the information that is responsive to the questions. This may include, for example, determining which products are applicable to the user's business, and/or how information related to the applicable products should be displayed. The results module 114, in conjunction with the HTTP server module 124 and/or the CMS 126, may then transmit information back to the client device 110 related to the products that have been determined by the results module 114 as applicable to the user's business.

The web site system 120 may also include one or more additional components or modules (not depicted), such as one or more load balancers, firewall devices, routers, switches, and devices that handle power backup and data redundancy.

The client device 110 may include a web browser module 112, which may communicate data related to the web site to/from the HTTP server module 124 in the web site system 120 via the one or more communication networks 102. The web browser module 112 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 112 may implement Rich Internet Application (RIA) and/or multimedia technologies such as Adobe Flash, Microsoft Silverlight, and/or other technologies. The web browser module 112 may implement RIA and/or multimedia technologies using one or web browser plug-in modules (such as, for example, an Adobe Flash or Microsoft Silverlight plugin), and/or using one or more sub-modules within the web browser module 112 itself. The web browser module 112 may display data on one or more display devices (not depicted) that are included in or connected to the client device 110, such as a liquid crystal display (LCD) display or monitor. The client device 110 may receive input from the user of the client device 110 from input devices (not depicted) that are included in or connected to the client device 110, such as a keyboard, a mouse, or a touch screen, and provide data that indicates the input to the web browser module 112. The client device 110 may be, for example, a cellular phone, a laptop computer, a tablet computer, or any other appropriate computing device.

The policy management system 104 may perform functionality such as managing information related to one or more insurance products held by the insurance company. The policy management system 104 may include a product management database 106, which may store information that describe clients of the insurance company and the policies products provided to the clients by the insurance company. The product management database 106 may be a relational database, a hierarchical database, an object-oriented database, one or more flat files, one or more spreadsheets, and/or one or more structured files. The product management database 106 may be managed by a database management system (not depicted). When a client enters into an agreement for the purchase of a product with the insurance company, information related to the agreement may be added to the product management database 106. Alternatively or additionally, when a user of the client device 110 enters into an agreement for the purchase of a product via the quoting/binding module 122 in the web site system 120, the quoting/binding module 122 may communicate with the policy management system 104, and the product management database 106 may be updated accordingly.

The one or more communication networks 102 in the example architecture 100 may include one or more private Local Area Networks (LANs), and/or one or more public communication networks such as the Internet. The one or more communication networks 102 may be based on wired and/or wireless networking technologies.

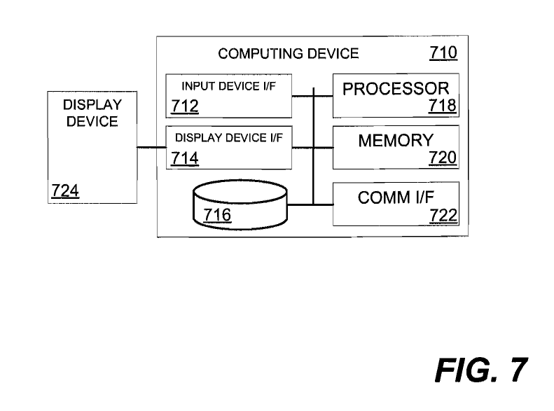

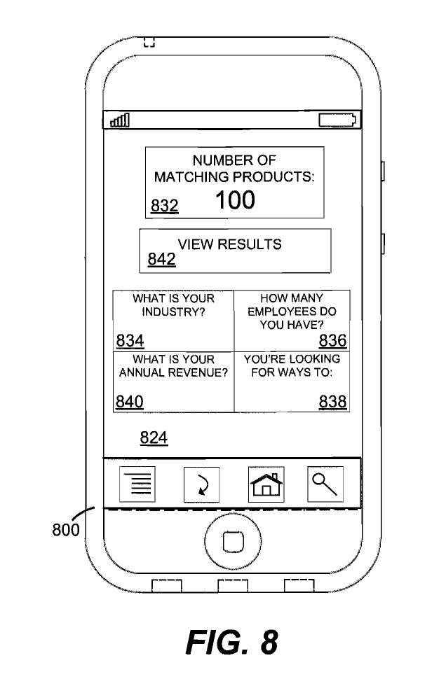

The architecture 100 of FIG. 1 may be implemented using any number of different network topologies and computing devices. For example, each of the quoting/binding module 122, HTTP service module 124, CMS 126, and results module 114 may be implemented using a single computing device, as one or more separate computing devices, or spread across any two or more computing devices, in any combination. Further, the policy management system 104 may be implemented using a single computing device, as one or more separate computing devices, or spread across any two or more computing devices. An example of a computing device that may be used for the implementation of any or any combination of these entities 122, 124, 126, 114, 104 is the computing device 700 that is described below with reference to FIG. 7. Alternatively or additionally, the client device 110 may be implemented using a computing device such as the computing device 700 that is described below with reference to FIG. 7 or the cellular phone 800 described below with reference to FIG. 8.

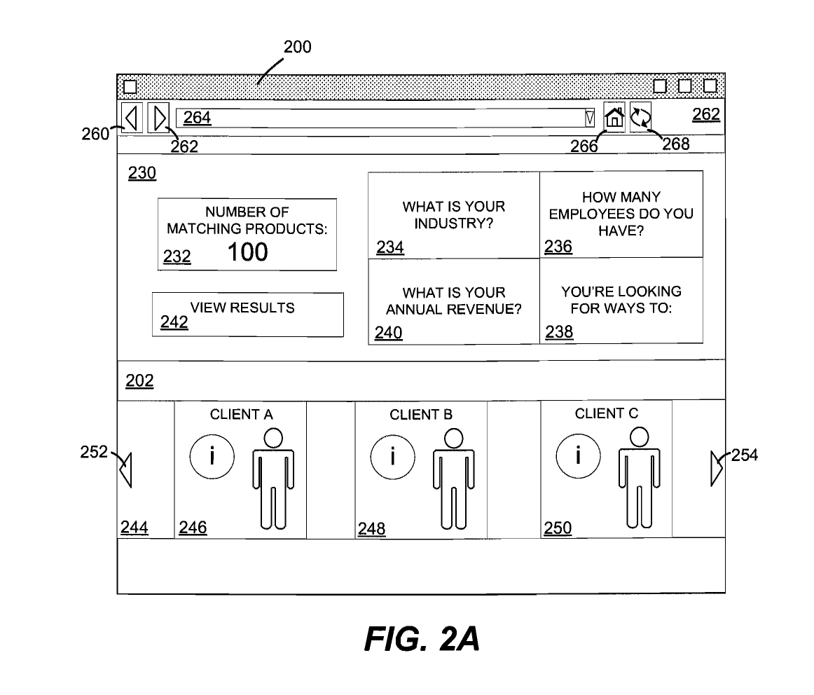

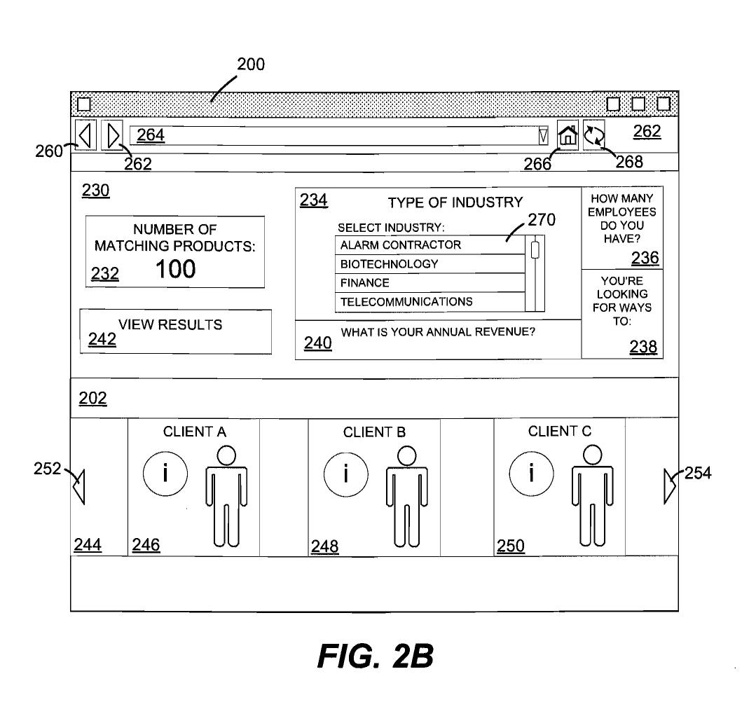

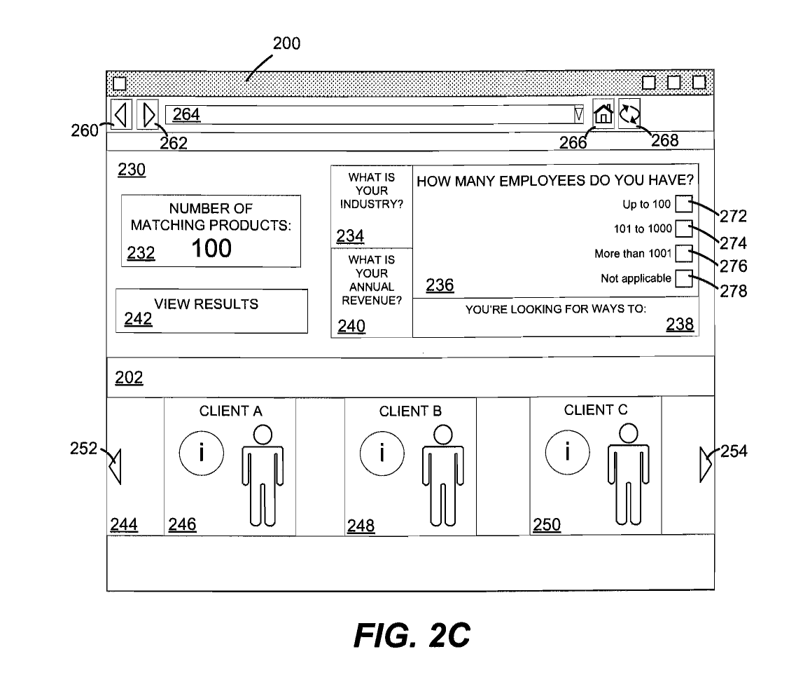

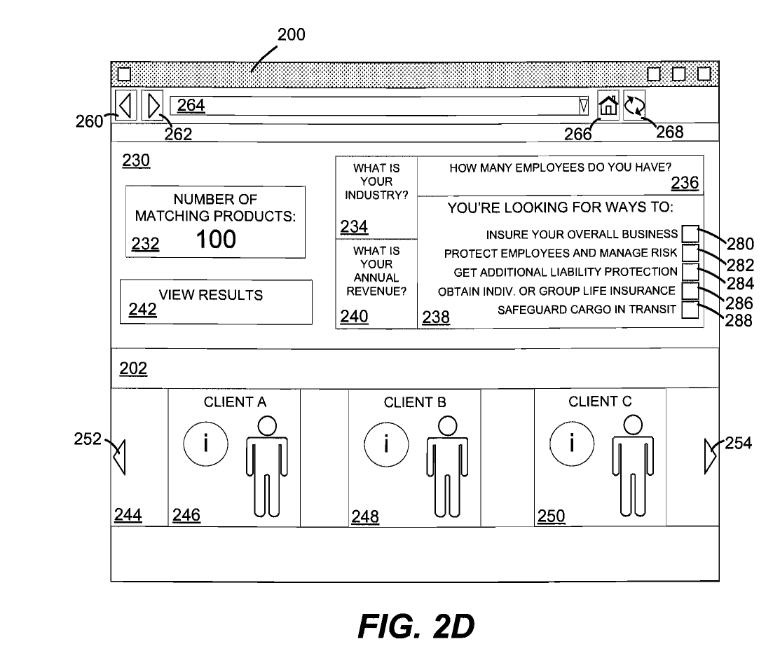

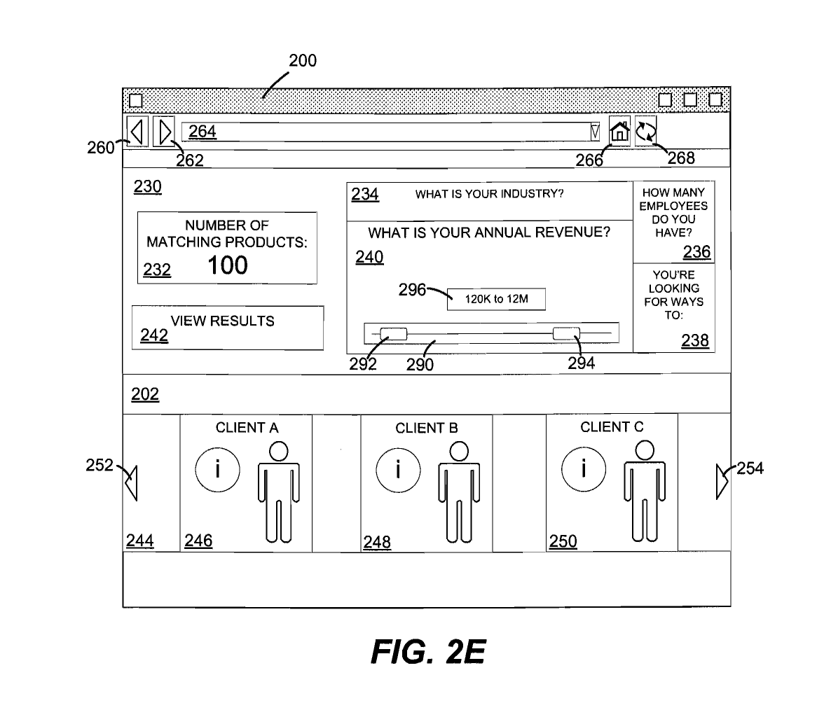

FIGS. 2A-2E show an example web page 202 that may be displayed by the web browser module 112. As will be described in detail below, the web page 202 may include display elements which prompt the user of the client device 110 for information about the user's business. The web page 202 may be included in a web browser window 200 that is displayed and managed by the web browser module 112. The web page 202 may include data received by the web browser module 112 from the web site system 120. The web page 202 may include information related to products sold by the insurance company, information related to clients that have purchased products sold by the insurance company, and other related information.

The web browser window 200 may include a control area 262 that includes a back button 260, forward button 262, address field 264, home button 266, and refresh button 268. The control area 262 may also include one or more additional control elements (not depicted). The user of the client device 110 may select the control elements 260, 262, 264, 266, 268 in the control area 262. The selection may be performed, for example, by the user clicking a mouse or providing input via keyboard, touch screen, and/or other type of input device. When one of the elements 260, 262, 264, 266, 268 is selected, the web browser module 112 may perform an action that corresponds to the selected element. For example, when the refresh button 268 is selected, the web browser module 112 may refresh the page currently viewed in the web browser window 200.

As shown in FIG. 2A, the web page 202 may include a product information area 230 and a client information area 244. The client information area 244 may include a first client profile area 246, a second client profile area 248, a third client profile area 250, a left button 252, and a right button 254. Each of the client profile areas 246, 248, 250 may include information that describes a business owner who has purchased one or more insurance products from the insurance company. The information included in the client profile areas 246, 248, 250 is information that is used for promotional and/or advertising purposes, and does not include any confidential information related to the relationship between clients and the insurance company.

FIG. 2A shows that the first client profile area 246 includes information related to an example client named “Client A,” the second client profile area 248 includes information related to an example client named “Client B,” and the third client profile area 250 includes information related to an example client named “Client C.”

According to this example, the first client profile area 246 may include information such as the industry Client A works in, the name of a business Client A operates, the number of employees employed by Client A's business, and/or other information. The first client profile area 246 may also include an image that is a picture of Client A. The user of the client device 110 may select the first client profile area 246. In response to a selection of the first client profile area 246, the web browser module 112 may open a new window (not depicted) that shows further information related to Client A. The new window may include, for example, video or other multimedia content that relates to Client A, Client A's business, and/or the product purchased by Client A from the insurance company. The video may include, for example, an interview with Client A, and/or other related content.

The second client profile area 248 and third client profile area 250 may include similar information as the first client profile area 246, though related to different clients (Client B and Client C). The web browser module 112 may open new windows (not depicted) when the second client profile area 248 and third filed 250 are selected in a similar or analogous fashion as that described above with respect to the first client profile area 246.

Periodically, web browser module 112 may move the client profile areas 246, 248, 250 within the client information area 244. Further, new client profile areas (not depicted) may be added to the client information area 244, and/or one or more of the three client profile areas 246, 248, 250 may be removed from the client information area 244. For example, the client profile areas 246, 248, 250 may periodically be shifted to the left, such that the second client profile area 248 is moved to the position of the first client profile area 246 as shown in FIG. 2A and the third client profile area 250 is moved to the position of the second client profile area 248 as shown in FIG. 2A. At the same time, a fourth field (not depicted) related to a fourth client (for example, “Client D”) may be moved to the position of the third client profile area 250 as shown in FIG. 2A. The movement of the client profile areas 246, 248, 250 (including the fourth field) may be displayed by the web browser module 112 with a smooth animation effect, so that the transitions between new and old positions are gradual in appearance. The fourth field, which is not included in the client information area 244 prior to the movement, may appear gradually from the right side of the client information area 244 until it is fully visible, before stopping in the position of the third client profile area 250 as shown in FIG. 2A. Similarly, the first client profile area 246 may appear to move gradually towards the left of the client information area 244 until it is no longer visible in the client information area 244.

Alternatively or additionally, the web browser module 112 may, in response to selection of the left button 252, move the client profile areas 246, 248, 250 to the left, using a smooth animation effect similar to that described above with respect to the period movement of the client profile areas 246, 248, 250. The web browser module 112 may also perform an analogous action in response to a selection of the right button 254, wherein the client profile areas 246, 248, 250 are shifted to the right.

The product information area 230 in the web page 202 may include a matching products area 232, first input field 234, a second input field 236, a third input field 238, a fourth input field 240, and a view results button 242. The input fields 234, 236, 238, 240 prompt the user of the client device 110 for different types of information. As shown in FIG. 2A, the four input fields 234, 236, 238, 240 show example questions (e.g., “What is your industry?”) that solicit information from the user of the client device 110. The example question for the first input field 234 relates to the type of industry with which the user's business is associated. The example question for the second input field 236 relates to the number of employees employed by the user's business. The example question for the third input field 238 relates to goals or intended purposes that the user has related to the products offered by the insurance company (e.g., insure their business on the whole, safeguard cargo in transit, or other goals). The example question for the fourth input field 240 relates to the annual revenue of the user's business. As will be described in further detail below, the user of the client device 110 may provide information that is responsive to the questions by selecting and entering information into the input fields 234, 236, 238, 240. Also as will be described in further detail below, when the user of the client device 110 selects one of the input fields 234, 236, 238, 240, additional display elements may be added to the input fields 234, 236, 238, 240, via which the user may provide responsive information.

The questions in the input fields 234, 236, 238, 240 may be classified as corresponding to one or more types of questions. For example, the questions in the first input field 234, second input field 236, and fourth input field 240 may be classified as corresponding to a first type of question, in that these questions relate to factual attributes of the user's business. The question in the third input field 238, on the other hand, is a question of a second type, as the question in third input field 238 relates to the user's goals and/or needs with respect to business insurance.

The web browser module 112 may store information that describes business insurance products offered by the insurance company. These products may include, for example, property insurance, general liability insurance, commercial automobile insurance, workers' compensation insurance, captive insurance, commercial umbrella insurance, management and professional liability insurance, commercial marine insurance, employer-sponsored individual life insurance, and/or other products. The web browser module 112 may further store information that describes the relationship between the data that may be input into the input fields 234, 236, 238, 240, and the insurance products. For example, the web browser module 112 may store information that indicates, for each product, whether that product is appropriate or not for each of the types of information that may be input into the input fields 234, 236, 238, 240. For example, the web browser module 112 may store information that indicates, for a particular product, to which industries the product is applicable. The example web browser module 112 may also store information that indicates, for that product, the size of business (in terms of numbers of employees) to which the product is applicable. The example web browser module 112 may also store information that indicates, for that product, the revenue ranges and goals/purposes to which the product is applicable.

As the user providers input into the input fields 234, 236, 238, 240, the web browser module 112 may store one or more data structures (“question response data”) that reflect the selections made in the input fields 234, 236, 238, 240. Further, as the selections are updated, the web browser module 112 may update the matching products area 232 to indicate a number of products offered by the insurance company that match the selections. As an example, the insurance company may offer a total of one hundred products, but only eighty products are applicable to the industry of biotechnology, and only forty products are applicable to employers that have more less than one hundred employees. Further to this example, the user may input into the first input field 234 that their industry is biotechnology; the web browser module 112 may then update its question response data to indicate that the user has selected biotechnology, and update the matching products area 232 to indicate that the number of matching products is eighty. Further, the user may input into second input field 236 that they have less than one hundred employees; the web browser module 112 may then update the question response data to indicate that the business has less than one hundred employees, and also update the matching products area 232 to indicate that the number of matching products is forty.

Referring now to FIG. 2B, FIG. 2B shows the web page 202 of FIG. 2A, wherein the first input field 234 has been selected. As shown in FIG. 2B, the size of the first input field 234 has increased versus the size of the first input field 234 as shown in FIG. 2A, while the sizes of the second input field 236, third input field 238, and fourth input field 240 have decreased with respect to their sizes as shown in FIG. 2A. Further, in response to the selection of the first input field 234, the text in the first input field 234 has been modified, and an industry selection area 270 has been added to the first input field 234. As shown in FIG. 2B, the industry selection area 270 includes a list of industries that may be selected by the user. Alternatively or additionally, the industry selection area 270 may be or include a text input field (not depicted), into which the user may type the name of their industry. In response to a selection of an industry in the industry selection area 270, the web browser module 112 may update its question response data accordingly. Further, in response to the selection, the web browser module 112 may analyze which products offered by the insurance company relate to the selected industry, and update the number of matching products indicated in the matching products area 232 accordingly. If the user has provided input into any of the three other input fields 236, 238, 240, those inputs will also be reflected in the update of the matching products area 232.

FIG. 2C shows the web page 202 of FIGS. 2A-2B, wherein the second input field 236 has been selected. As shown in FIG. 2C, the size of the second input field 236 has increased versus the size of the second input field 236 as shown in FIG. 2A, while the sizes of the first input field 234, third input field 238, and fourth input field 240 have decreased with respect to their sizes as shown in FIG. 2A. Further, in response to the selection of the second input field 236, four check boxes 272, 274, 276, 278 have been added to the second input field 236. The user of the client device 110 may indicate the number of employees associated with their business by selecting the check box of the four check boxes 272, 274, 276, 278 that best describes their business. In response to a selection of one of the four check boxes 272, 274, 276, 278, the web browser module 112 may update the question response data accordingly. Further, in response to the selection of one of the four check boxes 272, 274, 276, 278, the web browser module 112 may analyze which products offered by the insurance company relate to the selected number of employees, and update the number of matching products indicated in the matching products area 232 accordingly. If the user has provided input into any of the three other input fields 234, 238, 240, those inputs will also be reflected in the update of the matching products area 232

FIG. 2D shows the web page 202 of FIGS. 2A-2C, wherein the third input field 238 has been selected. As shown in FIG. 2D, the size of the third input field 238 has increased versus the size of the third input field 238 as shown in FIG. 2A, while the sizes of the first input field 234, second input field 236, and fourth input field 240 have decreased with respect to their sizes as shown in FIG. 2A. Further, in response to the selection of the third input field 238, five check boxes 280, 282, 284, 286, 288 have been added to the third input field 238. The user of the client device 110 may indicate intended goals/purposes by selecting the check boxes from the five check boxes 280, 282, 284, 286, 288 that reflect their goals/purposes. In response to a selection of one of the five check boxes 280, 282, 284, 286, 288, the web browser module 112 may update the question response data accordingly. Further, in response to the selection of one of the five check boxes 280, 282, 284, 286, 288, the web browser module 112 may analyze which products offered by the insurance company related to the selected goals/purposes, and update the number of matching products indicated in the matching products area 232 accordingly. If the user has provided input into any of the three other input fields 234, 236, 240, those inputs will also be reflected in the update of the matching products area 232.

FIG. 2E shows the web page 202 of FIGS. 2A-2D, wherein the fourth input field 240 has been selected. As shown in FIG. 2E, the size of the fourth input field 240 has increased versus the size of the fourth input field 240 as shown in FIG. 2A, while the sizes of the first input field 234, second input field 236, and third input field 238 have decreased with respect to their sizes as shown in FIG. 2A. Further, in response to the selection of the fourth input field 240, a slider display element 290 and revenue range display element 296 have been added to the fourth input field 240.

Via the slider display element 290, the user of the client device 110 may specify a revenue range that includes a lower bound and an upper bound. The slider display element 290 includes a lower bound handle 292 which is used to specify the lower bound in the revenue range, and an upper bound handle 294 which is used to specify the upper bound in the revenue range. Both handles 292, 294 are responsive to user input. When moved to the left in the slider display element 290, the handles 292, 294 indicate a lower value for their respective parameters; when moved to the right in the slider display element 290, the handles 292, 294 indicate a higher value for their respective parameters. The revenue range display element 296 displays the revenue range specified by the lower bound handle 292 and the upper bound handle 294. FIG. 2E shows an example wherein the lower bound handle 292 indicates a value of one-hundred and twenty thousand dollars and the upper bound handle 294 indicates a value of twelve million dollars; these values are also displayed in the revenue range display element 296.

In response to the user input that specifies a revenue range in the slider display element 290, the web browser module 112 may update the question response data accordingly. Further, in response to the user input that specifies the revenue range, the web browser module 112 may analyze which products offered by the insurance company relate to the selected goals, and update the number of matching products indicated in the matching products area 232 accordingly. If the user has provided input into any of the three other input fields 234, 236, 238 those inputs will also be reflected in the update of the matching products area 232.

As described above, the web browser module 112 may update the client profile areas 246, 248, 250 within the client information area 244 periodically, and/or in response to user input. Alternatively or additionally, the web browser module 112 may select the profiles that are included in the update the client profile areas 246, 248, 250 based on user input provided via one or any combination of the input fields 234, 236, 238, 240. For example, if the user has specified a revenue range using the fourth input field 240, the web browser module 112 may select determine that the profiles shown in the client information area 244 should relate to example clients whose businesses have an annual revenue similar to the annual revenue the user indicated in the fourth input field 240. The web browser module 112 may then update the client profile areas 246, 248, 250 to include information related to example clients that match the annual revenue indicated in the fourth input field 240. As a further example, if the user has specified an industry in the first input field 234, the web browser module 112 may determine that the profiles shown in the client information area 244 should relate to example clients whose businesses are in the same industry as the industry indicated in the first input field 234. The web browser module 112 may perform similar functionality, mutatis mutandis, related to the second input field 236 and/or the third input field 238.

Alternatively or additionally, if the user arrives at the web site managed by the web site system 120 via a search engine, the profiles displayed in the client information area 244 may be determined based on the search terms that were used to arrive at the web site. For example, if the user had used a search term that relates to a given industry, the profiles displayed in the client information area 244 may include profiles that relate to clients whose businesses are in the given industry.

Although the product information area 230 of FIGS. 2A-2E shows four input fields 234, 236, 238, 240, any number of input fields may be used in the product information area 230. And although specific example questions are described above as used in conjunction with the four input fields 234, 236, 238, 240, any appropriate questions and corresponding question response data may be used. Further, while examples of particular parameter values for question response data are described above (e.g., particular ranges for employee numbers and particular goals), question response data may include any appropriate parameter values. Additionally, while specific display elements are described above as used for receiving user input data (e.g., the industry selection area 270 and the slider display element 290), any combination of the above-described types of display elements and/or other types of display elements may be used for receiving user input data.

Referring now to FIGS. 2A-2E, the view results button 242 in the product information area 230 in the web page 202 may be selected by the user. In response to the selection, the web browser module 112 may transmit the question response data (which may be based on user input, as described above) to the web site system 120. This may include, for example, the web browser module 112 transmitting information related to the question response data to the HTTP server module 124. For example, the web browser module 112 may send one or more HTTP GET or POST messages to the HTTP server module 124 that include one or more parameters that include the question response data. The HTTP server module 124 may then provide the question response data to the results module 114. The results module 114 may then determine which products match the selections indicated in the question response data, as well as the relevance of the products to the users based on the question response data. Further, the results module 114 may rank the products in terms of relevance to the user, based on the question response data. Additionally, the results module 114 may determine how a results web page that includes information related to the products should appear, based on the question response data. This may include, for example, determining how information related the products should be formatted based on their rank and/or relevance to the user. The results module 114, in conjunction with the HTTP server module 124 and/or the CMS 126, may then generate information that describe a results web page, and send the information to web browser module 112 in the client device 110 using an HTTP response that is responsive to the receive HTTP GET or POST described above.

In addition to the question response data, the web browser module 112 may obtain data obtained directly from other modules (not depicted) in the client device 110, without input from the user of the client device 110. This may include, for example, location information that may be obtained from a Global Positioning System (GPS) module (not depicted) in the client device 110, and/or other data. This additional information may be transmitted by the web browser module 112 along with the question response data that is sent to the results module 114. The results module 114 may use this additional data in determining whether a product is available to a user, determining product relevance, and/or determining how the results web page that includes the information related to the products should appear.

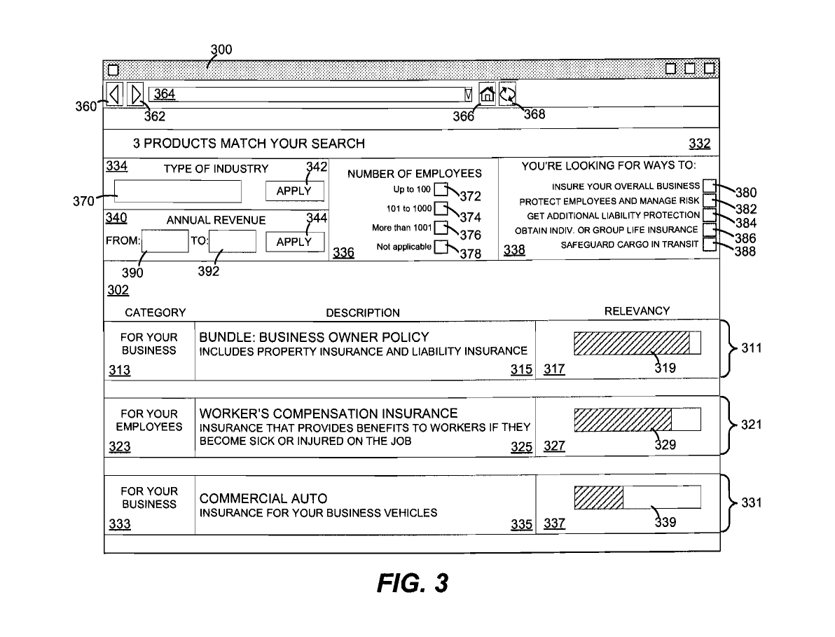

FIG. 3 shows an example results web page 302 that includes information generated by the results module 114, and which may be displayed by the web browser module 112. According to the example of FIG. 3, the results module 114 determined the contents of the example results web page 302 based on question response data, and the information that describes the contents of the example results web page 302 was received by the web browser module 112.

The results web page 302 may be included in the web browser window 300, which has similar characteristics to the web browser window 200 described above with reference to FIGS. 2A-2E. The web browser window 300 may include a control area 362 that includes a back button 360, forward button 362, address field 364, home button 366, and refresh button 368. The control area 362 may also include one or more additional control elements (not depicted). The user of the client device 110 may select the control elements 360, 362, 364, 366, 368 in the control area 362. When one of the elements 360, 362, 364, 366, 368 is selected, the web browser module 112 may perform an action that corresponds to the selected element.

The results web page 302 includes a matching products field 332 that indicates a number of products that match the selections indicated in the question response data received by the results module 114. The results web page 302 further includes a first result row 311, second result row 321, and third result row 331, each of which include information related to one of the products that match the selections. The products may be individual products, and/or may include “bundle” products. A bundle product may be an aggregate of two or more products, or may be a recommended grouping of two or more individual products. The first result row 311 includes a category area 313 that describe a category for the product, a description area 315 that include a description of the product, and a relevancy area 317 that includes a relevancy graphic 319 that indicates the relevancy of the product based on the selections indicated in the question response data. The second result row 321 and third result row 331 also include category areas 323,333, description areas 325, 335, relevancy areas 327, 337, and relevancy graphics 329, 339, with similar characteristics to the analogous elements 313, 315, 317, 319 in the first result row 311. As shown in FIG. 3, the relevancy graphic 319 in the first result row 311 includes a larger shaded area than the relevancy graphic 329 in the second result row 321, which in turn includes a larger shaded area than the relevancy graphic 339 in the third result row 331. This indicates that the product corresponding to the first result row 311 was determined by the results module 114 to be more relevant than the product corresponding to the second result row 321, and so on.

The results web page 302 also includes a first input update field 334, a second input update field 336, a third input update field 338, and a fourth input update field 340. These input update fields 334, 336, 338, 340 may receive input data that is similar to the input data described above as received by the four input fields 234, 236, 238, 240 in the web page 202 of FIGS. 2A-2E. The first input update field 334 may include an industry input area 370, which may receive text input that describes the industry of the user of the client device 110. The first input update field 334 may also include an apply button 342. The second input update field 336 may include four checkboxes 372, 374, 376, 378. The third input update field 338 may include five checkboxes 380, 382, 384, 386, 388. The fourth input update field 340 may include a lower bound field 390 and an upper bound field 392, both of which may receive text input. The fourth input update field 340 may also include an apply button 342.

When either of the apply buttons 342, 344 or any of the checkboxes 372, 374, 376, 378, 380, 382, 384, 386, 388 are selected, the web browser module 112 may generate one or more data structures that reflect the values indicated in the four input update fields 334, 336, 338, 340. The web browser module 112 may then transmit the data from the four input fields 334, 336, 338, 340 to the web site system 120. The results module 114 may then receive the data, and process the data in the same way that the results module 114 processes question response data, as described above. The web site system 120 may then transmit a new results page to the web browser module 112. The new results page may have a similar or identical format to the results web page 302 shown in FIG. 3. The web browser module 112 may display the new results page in the web browser window 300.

The description areas 315, 325, 335 may be responsive to user input. In response to the user input, the web browser module 112 may perform a number of different actions. For example, the web browser module 112 may then navigate to a web page (not depicted) that is related to the quoting/binding module 122. The user of the may then, using the web browser module 112 and by interacting with the quoting/binding module 122 and/or the policy management system 104, obtain a price quote for an insurance product or enter into a binding agreement to purchase an insurance product from the insurance company. Information related to the user's business (i.e., information such as that shown in the four input update fields 334, 336, 338, 340) that was entered in FIG. 3 may be communicated to the quoting/binding module 122 and/or the policy management system 104, to facilitate obtaining the quote or the purchase of the insurance product. Alternatively or additionally, in response to a user input in one of the description areas 315, 325, 335, the web browser module 112 may navigate to a web page that has contact information (such as a phone number and/or email address) for an employee or agent of the insurance company. The employee or agent may specialize in the product that corresponds to the selected description area 315, 325, 335. The user may then contact the employee/agent via phone and/or email, and initiate the purchase of a product from the insurance company. Alternative or additionally, in response to a user input in one of the description areas 315, 325, 335, the web browser module 112 may navigate to a web page within the web site of the insurance company that provides more information related to the product that corresponds to the selected description area 315, 325, 335. The web page may include an E-Book and/or other information related to the product that corresponds to the selected description area 315, 325, 335.

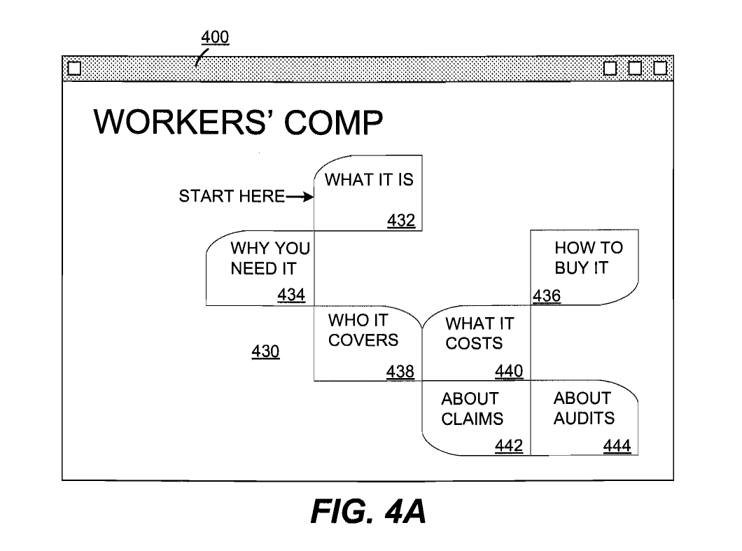

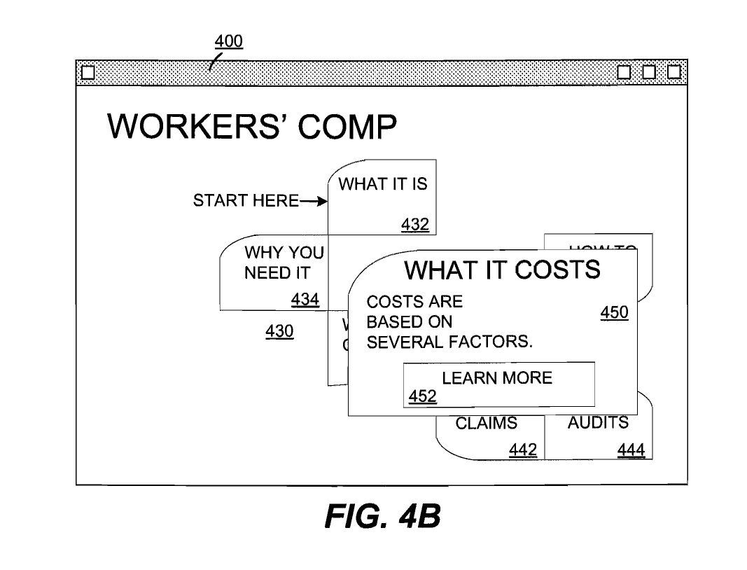

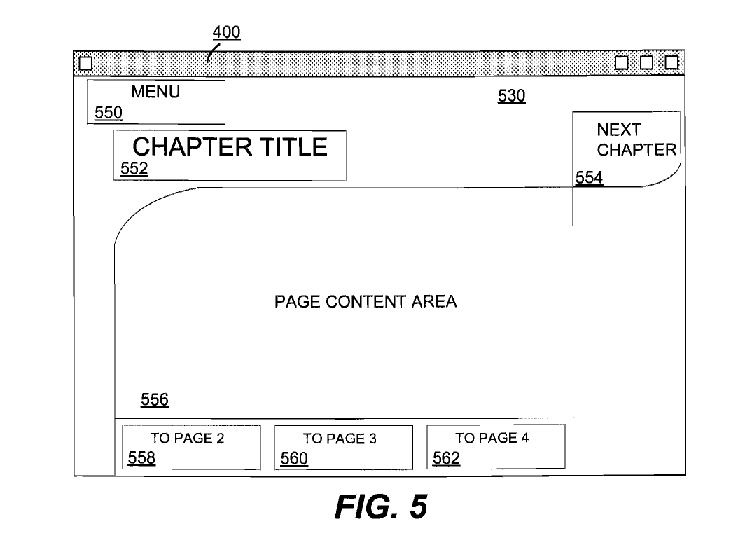

FIGS. 4A-4B and FIG. 5 show an example E-Book that may be displayed by the web browser module 112. The example E-Book of FIGS. 4A-4B and FIG. 5 provides information related to workers' compensation products offered by the insurance company. A web page on which this example E-Books is embedded or linked to may be navigated to by the web browser module 112 in response to, for example, selecting one of the description areas 315, 325, 335 described above with reference to FIG. 3. The E-Book of FIGS. 4A-4B and FIG. 5 may be implemented using Flash, HTML5, Microsoft Silverlight, and/or any other appropriate technology.

FIG. 4A shows that the E-Book may be displayed with a web browser window 400. FIG. 4A shows a chapter menu 430 for the E-Book. The chapter menu 430 includes seven chapter link areas 432, 434, 436, 438, 440, 442, 444, which link to the different chapters in the E-Book.

The chapter link areas 432, 434, 436, 438, 440, 442, 444 may be selectable based on user input. When one of the link areas 432, 434, 436, 438, 440, 442, 444 is selected, the web browser module 112 may display a pop up display element within the web browser window 400 that provides more information related to the chapter that corresponds to the selected link area may be displayed.

FIG. 4B shows an example pop up display element 450 that may be displayed when the “What It Costs” chapter link area 440 from the chapter menu 430 is selected. The pop up display element 450 includes a Learn More area 452. The Learn More area 452 may be responsive to user input. In response to a selection of the Learn More area 452, the web browser module 112 may display the first page of the “What It Costs” chapter of the E-Book.

FIG. 5 shows an example first page 530 of a chapter in the E-Book. The first page 530 may include a menu area 550, a page content area 556, three page link areas 558, 560, 562, and a next chapter area 554, all of which are responsive to user input. The first page 530 may also include a chapter title area 552. In response to a selection of the menu area 550, the web browser module 112 may modify the web browser window 400, such that the chapter menu 430 described above with reference to FIGS. 4A-4B is displayed in the web browser window 400. The page content area 556 may include the contents for the first page 530. The contents may include any combination of text, video, and/or interactive display elements related to the subject matter of the chapter. In response to a selection of one of the page link areas 558, 560, 562, the web browser module 112 may modify the web browser window 400, such that the selected page is displayed in the web browser window 400. In response to a selection of the next chapter area 554, the web browser module 112 may modify the web browser window 400, such that the first page of the next chapter of the E-Book is displayed in the web browser window 400.

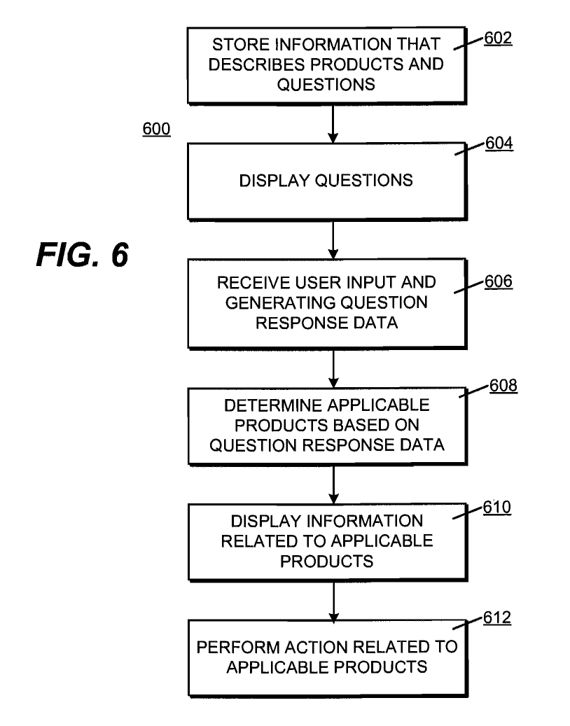

FIG. 6 shows an example method 600 for obtaining and processing information related to business insurance products. The method 600 of FIG. 6 may begin with storing information that describes the business insurance products offered by an insurance company in a computer-readable medium (step 602). This information may also include information that represents one or more questions that solicit information regarding the user's business. The questions may then be displayed to the user via one or more display devices (step 604).

Next, user input data that is responsive to the questions may be received and, in response to the user input, question response data may be generated (step 606). The user input may be received via one or more input devices, such as a keyboard, a mouse, a trackball, a touch screen, a touch pad, a stylus pad, and/or other input device. The question response data may indicate information such as the type of industry of the business, the number of employees in the business, the annual revenue of the business, and/or goals the user may have with respect to the insurance products.

Then, a determination is made regarding which of the insurance products match the question response data (step 608). This may also include, for example, determining the respective relevancies of the insurance products based on the question response data. Alternatively or additionally, this may include determining how information regarding the matching products should be displayed.

Information regarding the products which have been determined to match the question response data may then be displayed via one or more display devices (step 610). Based on the displayed data, one or more actions related to the matching products may then be performed (step 612). These actions may include, for example, obtaining additional information related to the matching products, initiating the purchase of a product (by, for example, contacting an agent or employee of the insurance company), and/or enter into a binding agreement for the purchase of a product.

FIG. 7 shows an example computing device 710 that may be used to implement features describe above with reference to FIGS. 1-6. The computing device 710 may include a processor 718, memory device 720, communication interface 722, input device interface 712, display device interface 714, and storage device 716. FIG. 7 also shows a display device 724, which may be coupled to or included within the computing device 710.

The memory device 720 may be or include a device such as a Dynamic Random Access Memory (D-RAM), Static RAM (S-RAM), or other RAM or a flash memory. The storage device 716 may be or include a hard disk, a magneto-optical medium, an optical medium such as a CD-ROM, a digital versatile disk (DVDs), or Blu-Ray disc (BD), or other type of device for electronic data storage.

The communication interface 722 may be, for example, a communications port, a wired transceiver, a wireless transceiver, and/or a network card. The communication interface 722 may be capable of communicating using technologies such as Ethernet, fiber optics, microwave, xDSL (Digital Subscriber Line), Wireless Local Area Network (WLAN) technology, wireless cellular technology, and/or any other appropriate technology.

The input device interface 712 may be an interface configured to receive input from an input device such as a keyboard, a mouse, a trackball, a touch screen, a touch pad, a stylus pad, and/or other device. The input device interface 712 may operate using a technology such as Universal Serial Bus (USB), PS/2, Bluetooth, infrared, and/or other appropriate technology.

The display device interface 714 may be an interface configured to communicate data to display device 724. The display device 724 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 714 may operate using technology such as Video Graphics Array (VGA), Super VGA (S-VGA), Digital Visual Interface (DVI), High-Definition Multimedia Interface (HDMI), or other appropriate technology. The display device interface 714 may communicate display data from the processor 718 to the display device 724 for display by the display device 724. As shown in FIG. 7, the display device 724 may be external to the computing device 710, and coupled to the computing device 710 via the display device interface 714. Alternatively, the display device 724 may be included in the computing device 700.

An instance of the computing device 710 of FIG. 7 may be configured to perform any feature or any combination of features described above as performed by the client device 110. In such an instance, the memory device 720 and/or the storage device 716 may store instructions which, when executed by the processor 718, cause the processor 718 to perform any feature or any combination of features described above as performed by the web browser module 112. In such an instance, the computing device 710 may be, for example, a laptop computer, a tablet computer, a desktop computer, cellular phone (such as but not limited to the cellular phone 800 described below with reference to FIG. 8), a personal digital assistant (PDA), or any other appropriate computing device.

Alternatively or additionally, an instance of the computing device 710 may be configured to perform any feature or any combination of features described above as performed by the quoting/binding module 122, HTTP service module 124, CMS 126, and/or results module 114. In such an instance, the memory device 720 and/or the storage device 716 may store instructions which, when executed by the processor 718, cause the processor 718 to perform any feature or any combination of features described above as performed by the quoting/binding module 122, HTTP service module 124, CMS 126, and/or results module 114. In such an instance, the computing device 710 may be a server computer or any other appropriate computing device.

Further, an instance of the computing device 710 may be configured to perform any features or combination of features described above as performed by the policy management system 104. In such an instance, the memory device 720 and/or the storage device 716 may store instructions which, when executed by the processor 718, cause the processor 718 to perform any feature or any combination of features described above as performed by the policy management system 104. In such an instance, the computing device 710 may be a server computer or any other appropriate computing device.

FIG. 8 shows a cellular phone 800 that is a more specific example of the computing device 700 described above with reference to FIG. 7. The cellular phone may include a touch screen 824, and may also include a processor (not depicted), memory device (not depicted), communication interface (not depicted), input device interface (not depicted), display device interface (not depicted), and storage device (not depicted), which may possess characteristics of processor 718, memory device 720, communication interface 722, input device interface 712, display device interface 714, and storage device 716 described above with reference to FIG. 7. The touch screen 824 is a more specific example of the display device 724 described above with reference to FIG. 7, and may be based on technology such as, for example, LCD, LED, and/or other appropriate display technology. The touch screen 824 may receive user input using technology such as, for example, resistive sensing technology, capacitive sensing technology, optical sensing technology, or any other appropriate touch-sensing technology. The touch screen 824 may provide user input data to the input device interface (not depicted) in the cellular phone 800. The communication interface (not depicted) in the cellular phone may be a wireless transceiver, and may be capable of communicating using wireless technology such as Long Term Evolution (LTE), LTE-Advanced (LTE-A), Universal Mobile Telecommunications System (UMTS), IEEE Institute of Electrical and Electronics Engineers (IEEE) 802.16/WiMax, IEEE 802.16m, Wireless Broadband (WiBro), Global System for Mobile Communications (GSM), Enhanced Data Rates for GSM Evolution (EDGE) Radio Access Network (GERAN), Code Division Multiple Access 2000 (CDMA2000), and/or any other appropriate wireless technology.

The touch screen 824, as shown in FIG. 8, may display a matching products area 832, first input field 834, a second input field 836, a third input field 838, a fourth input field 840, and a view results button 842. As described above with reference to FIG. 7, the processor in the cellular phone 800 may execute instructions which cause the processor to perform the functionality described above as performed by the web browser module 112. This may include displaying the display elements 832, 834, 836, 838, 840, 842 in the touch screen 824, as shown in FIG. 8. These display elements 832, 834, 836, 838, 840, 842 may display similar data and receive user input in a similar fashion as that described above with respect to the corresponding display elements 232, 234, 236, 238, 240, 242 of FIGS. 2A-2E. A user of the cell phone 800 may interface with these display elements 832, 834, 836, 838, 840, 842 by using the touch screen 824.

Although examples are provided above with reference to FIGS. 1-8 wherein data is communicated between a web site system 120 and a web browser module 122, the features described above as performed by the web site system 120 and/or the web browser module 122 may be implemented in any combination of software and/or hardware. For example, the features described above as performed by the web browser module 122 and/or the web site system 120 may be performed, mutatis mutandis, by one or more dedicated or special-purpose applications.

Although examples are provided above with respect to businesses, business owners, and business insurance product, the features describe above with reference to FIGS. 1-8 are equally applicable, mutatis mutandis, to other contexts. For example, the features described above may be used for the communication of information related to and/or the selection of insurance products that are applicable to all types of insurance consumers, including individuals, businesses, non-profit entities, governmental entities, and/or any other types of insurance consumers. For example, the features described above may be used for communication of information related to and/or the selection of individual insurance products, and/or any other insurance products. Alternatively or additionally, the features described above may be used for the communication of information related to and/or the selection of financial products that are not insurance products, such as risk management services, bonds, retirement plans, savings plans, and/or group benefits plans.

When referred to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other device for electronic data storage.

As used herein, the term “processor” broadly refers to and is not limited to a single- or multi-core general purpose processor, a special purpose processor, a conventional processor, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Although features and elements are described above in particular combinations, each feature or element can be used alone or in any combination with the other features and elements. For example, each feature or element described above with reference to any one or any combination of FIGS. 1-8 may be used alone without the other features and elements or in various combinations with or without other features and elements described above with reference to any one or any combination of FIGS. 1-8. Sub-elements of the methods and features described above may be performed in any arbitrary order (including concurrently), in any combination or sub-combination.

What is claimed is:

1. A system for the processing and display of information related to business insurance products offered by an insurance company, the system comprising:
a memory device configured to store information related to at least two business insurance products;
a display device configured:
to display information to a user that indicates questions related to a business, wherein the questions request information that describes:
a type of industry of the business;
a number of employees of the business; and
an annual revenue of the business; and
to display a field that indicates a number of the at least two business insurance products that are applicable to the business;
an input interface configured to receive input data from the user that is responsive to the questions; and
at least one processor configured,
for each of the questions,
to determine, based on the input data, the number of the at least two business insurance products that are applicable to the business, and
to update the field that indicates the number of the at least two business insurance products that are applicable to the business;
wherein the at least one processor is further configured to determine, based on the input data, which of the at least two business insurance products are applicable to the business;
wherein the display device is further configured to display information related to the determined business insurance products.

2. The system of claim 1, wherein
the memory device is further configured to store information that describes profiles of at least two clients of the insurance company,
the at least one processor is configured to select profiles from the profiles of at least two clients of the insurance company based on the input data, and
the display device is further configured to display the selected profiles.

3. The system of claim 1, wherein the information related to the determined business insurance products includes, for each of the determined business insurance products, information that indicates a relative relevancy of the determined business insurance products to the business.

4. The system of claim 1, wherein the at least two business insurance products include one or more of:
property insurance;
general liability insurance;
commercial automobile insurance; or
workers' compensation insurance.

5. The system of claim 1, wherein the at least two business insurance products include one or more of:
captive insurance;
commercial umbrella insurance;
management or professional liability insurance;
commercial marine insurance; or
employer-sponsored life insurance.

6. The system of claim 1, wherein
the questions further request information that describes a goal of the user for the at least two business insurance products,
the input data further includes the goal of the user for the at least two business insurance products, and
the goal is one of:
obtaining insurance for the business;
protecting employees of the business and managing risk of the business;
obtaining additional liability protection for the business;
obtaining individual or group life insurance; or
safeguarding cargo in transmit.

7. The system of claim 1, further comprising:
a communication interface configured to transmit data to obtain a price quote and bind coverage for one of the business insurance products that are applicable to the business.

8. The system of claim 1, wherein input data for at least one of the questions is provided from a search engine.

9. A computer-implemented method for the processing and display of information related to insurance products offered by an insurance company, the method comprising:
a memory device storing information related to at least two insurance products that may be purchased by an insurance consumer;
a display device displaying information that indicates questions related to the insurance consumer and displaying a field that indicates a number of the at least two insurance products that are applicable to the insurance consumer;
an input interface receiving input data from a user, wherein the input data is responsive to the questions;
at least one processor
determining, for each of the questions, the number of the at least two insurance products that are applicable to the insurance consumer based on the input data, and
updating, for each of the questions, the field that indicates the number of the at least two insurance products that are applicable to the insurance consumer;
the at least one processor determining, based on the input data, which of the at least two insurance products are applicable to the insurance consumer; and
the display device displaying information related to the determined insurance products.

10. The computer-implemented method of claim 9, further comprising:
the memory device storing information that describes profiles of at least two clients of the insurance company;
the at least one processor selecting profiles from the profiles of at least two clients of the insurance company based on the input data, and
the display device displaying the selected profiles.

11. The computer-implemented method of claim 9, wherein the information related to the determined insurance products includes, for each of the determined insurance products, information that indicates a comparative relevancy of the determined insurance product to the insurance consumer.

12. The computer-implemented method of claim 9, wherein the insurance consumer is a business, and wherein the questions request information that describes one or more of:
a type of industry of the business;
a number of employees of the business; or
an annual revenue of the business.

13. The computer-implemented method of claim 12, wherein the at least two insurance products include one or more of:
property insurance;
general liability insurance;
commercial automobile insurance; or
workers' compensation insurance.

14. The computer-implemented method of claim 12, wherein the at least two insurance products include one or more of:
captive insurance;
commercial umbrella insurance;
management or professional liability insurance;
commercial marine insurance; or
employer-sponsored life insurance.

15. The computer-implemented method of claim 9, wherein
the questions further request information that describes a goal of the user for the at least two insurance products, and
the input data further includes the goal of the user for the at least two insurance products.

16. The computer-implemented method of claim 15, wherein the insurance consumer is a business, and wherein the goal is one of:
obtaining insurance for the business;
protecting employees of the business and managing risk of the business;
obtaining additional liability protection for the business;
obtaining individual or group life insurance; or
safeguarding cargo in transmit.

17. The computer-implemented method of claim 9, further comprising:
a communication interface transmitting data to purchase one of the insurance products that are applicable to the insurance consumer.

18. The computer-implemented method of claim 9, further comprising:
a communication interface transmitting data to obtain a price quote for one of the insurance products that are applicable to the insurance consumer.

19. A computer-readable medium having processor-executable instructions stored thereon which, when executed by at least one processor, will cause the at least one processor to perform a method for the processing and display of information related to financial products offered by a financial services company, the method comprising:
storing information related to at least two financial products that may be purchased by a consumer;
displaying information that indicates questions,
wherein the questions include one or more questions of a first question type and one or more questions of a second question type,
wherein the first question type relates to attributes of the consumer, and
wherein the second question type relates to goals of the consumer for the at least two financial products;
displaying a field that indicates a number of the at least two financial products that are applicable to the consumer;
receiving input data from a user, wherein the input data is responsive to the questions;
for each of the questions,
determining the number of the at least two financial products that are applicable to the consumer based on the input data and
updating the field that indicates the number of the at least two financial products that are applicable to the consumer;
determining, based on the input data, which of the at least two financial products are applicable to the consumer; and
displaying information related to the financial products that are applicable to the consumer.

20. The computer-readable medium of claim 19, wherein the method further comprises:
storing information that describes profiles of at least two clients of the financial services company;
select profiles from the profiles of at least two clients of the financial services company based on the input data; and
displaying the selected profiles.

21. The computer-readable medium of claim 19, wherein the information related to the determined financial products includes, for each of the determined financial products, information that indicates a relevancy of the determined financial products to the consumer.

22. The computer-readable medium of claim 19, wherein the information related to the determined financial products includes, for each of the determined financial products, information that indicates a relative relevancy of the determined financial products to the consumer.

23. The computer-readable medium of claim 19, wherein the consumer is a business, and wherein the one or more questions of the first question type request information that describes one or more of:
a type of industry of the business;
a number of employees of the business; or
an annual revenue of the business.

24. The computer-readable medium of claim 19, wherein the consumer is a business, and wherein the one or more questions of the first question type request information that describes one or more of:
a type of industry of the business;
a number of employees of the business; or
an annual revenue of the business.

25. The computer-readable medium of claim 19, wherein the at least two financial products include one or more of:
property insurance;
general liability insurance;
commercial automobile insurance; or
workers' compensation insurance.

26. The computer-readable medium of claim 19, wherein the at least two financial products include two or more of:
captive insurance;
commercial umbrella insurance;
management or professional liability insurance;
commercial marine insurance;
employer-sponsored life insurance;
bonds;
a retirement plan;
a savings plan; or
a group benefits plan.

27. The computer-readable medium of claim 19, wherein the consumer is a business, and wherein the one or more questions of the second question type include one or more questions related to:
obtaining insurance for the business;
protecting employees of the business and managing risk of the business;
obtaining additional liability protection for the business;
obtaining individual or group life insurance; or
safeguarding cargo in transmit.

28. The computer-readable medium of claim 19, wherein the method further comprises:
a communication interface transmitting data to purchase one of the financial products that are applicable to the consumer.

29. The computer-readable medium of claim 19, wherein the method further comprises:
a communication interface transmitting data to obtain a price quote for one of the financial products that are applicable to the consumer.
